(19) United States
(12) Patent Application Publication
(10) Pub. No.: US 2007/0028198 A1
(43) Pub. Date: Feb. 1, 2007

(54) METHOD AND APPARATUS FOR ALLOCATING DATA PATHS TO MINIMIZE UNNECESSARY POWER CONSUMPTION IN FUNCTIONAL UNITS

(75) Inventors: Wei Lee NEW, Singapore (SG); Yudhi SANTOSO, Singapore (SG)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/460,422

(22) Filed: Jul. 27, 2006

(30) Foreign Application Priority Data
Jul. 29, 2005 (JP) 2005-220281

(51) Int. Cl. G06F 17/50

(52) U.S. Cl. 716/3; 716/18; 716/7; 716/1

(57) ABSTRACT

A method and apparatus to produce high-level synthesis Register Transfer Level designs utilises power management formulations can be used to gear the allocation process to generate hardware architecture of minimal spurious switching. Bipartite weighted Assignment is used to determine the sharing of functional units, through cost formulations and the Hungarian Algorithm.

### BACKGROUND OF THE INVENTION

1. Field of the Invention

This invention relates to allocating data paths, for instance in circuit design.

2. Background Art

In circuit design, a designer may start with a behavioural description, which contains an algorithmic specification of the functionality of the circuit. High-level synthesis converts the behavioural description of a very large scale integrated (VLSI) circuit into a structural, register-transfer level (RTL) implementation. The RTL implementation describes an interconnection of macro blocks (e.g., functional units, registers, multiplexers, buses, memory blocks, etc.) and random logic.

A behavioural description of a sequential circuit may contain almost no information about the cycle-by-cycle behaviour of the circuit or its structural implementation. High-level synthesis (HLS) tools typically compile a behavioural description into a suitable intermediate format, such as Control-Data Flow Graph (CDFG). Vertices in the CDFG represent various operations of the behavioural description. Data and control edges are used to represent data dependencies between operations and the flow of control.

High-level synthesis tools typically perform one or more of the following tasks: transformation, module selection, clock selection, scheduling, resource allocation and assignment (also called resource sharing or hardware sharing). Scheduling determines the cycle-by-cycle behaviour of the design by assigning each operation to one or more clock cycles or control steps. Allocation decides the number of hardware resources of each type that will be used to implement the behavioural description. Assignment refers to the binding of each variable (and the corresponding operation) to one of the allocated registers (and the corresponding functional units).

In VLSI circuits, the dynamic components that are incurred whenever signals in a circuit undergo logic transition, often dominate power dissipation. However, not all parts of the circuit need to function during each clock cycle. As such, several low power design techniques have been proposed based on suppressing or eliminating unnecessary signal transitions. In general, the term used to refer to such techniques is power management. In the context of data path allocation, power management can be applied to data path allocation using the following technique:

Operand Isolation

Inserting transparent latches at the inputs of an embedded combinational logic block, and additional control circuitry to detect idle conditions for the logic block. The outputs of the control circuitry are used appropriately to disable the latches at the inputs of the logic block from changing values. Thus, the previous cycles input values are retained at the inputs of the logic block under consideration, eliminating unnecessary power dissipation.

The operand isolation technique has two disadvantages. The signals that detect idle conditions for various sub-circuits typically arrive late (for example, due to the presence of nested conditionals within each controller state, the idle conditions may depend on outputs of comparators from the data path). Therefore, the timing constraints that must be imposed (i.e. the enable signal to the transparent latches must settle before its data inputs can change) are often not met, thus making the suppression ineffective. Further, the insertion of transparent latches in front of functional units can lead to additional delays in a circuit's critical path and this may not be acceptable in signal and image-processing applications that need to be fast as well as power efficient.

This patent aims to address the power consumption minimization in data path allocations for chained operations. In data path allocations, power consumption of a circuitry can be minimized by allocating operations to functional units in discretion. Refer to FIG. 1, unnecessary power consumption is incurred for data path allocation due to unnecessary power dissipation in ALU 2, whereas for a better data path allocation scheme (FIG. 2), no unnecessary power loss results from the functional unit sharing. If all functional units are not shared, there will not be any unnecessary power loss. However, this is inexpedient due to the large hardware costs. Power loss can be minimized by considering the respective unnecessary power costs of the eligible operation candidates that may be incurred for the possible operations to functional units assignments in the data path allocation.

Consider the pair of alternatives data path allocation schemes shown in FIG. 3 and 4. Assume that extractor consumes less power than multiplier on the average. It can be seen that the scheme as shown in FIG. 3 has lower power dissipations as the unnecessary power loss in extractor is much lesser than the unnecessary power loss incurred in the multiplier. The unnecessary power loss for shifter when the extractor or multiplier is utilized is the same assuming a common switching frequency for the input to the multiplier and extractor. The data path allocation scheme in FIG. 3 is thus more favourable in power dissipations considerations compared to that shown in FIG. 4.

### SUMMARY OF THE INVENTION

According to one aspect of the present invention, there is provided a method of data path allocation. The method comprises generating an allocation of resources with power costs formulation to reduce the unnecessary power consumption in functional units.

According to another aspect of the present invention, there is provided apparatus for data path allocation. The apparatus comprises means for generating allocation of resources.

According to yet another aspect of the invention there is provided a computer program product having a computer program recorded on a computer readable medium, for data path allocation. The computer program product comprises computer program code means for computing the relative unnecessary power consumption in the resources for different alternatives of functional units sharing, and using these information to generate low power resources.

Embodiments of the invention can be used to generate circuits with minimum unnecessary power consumption in chained operations.

### BRIEF DESCRIPTION OF THE DRAWINGS

The invention is described by way of non-limitative example with reference to the accompanying drawings, in which:

FIG. 1 illustrates sharing of functional unit without discretion, resulting in unnecessary power consumption in ALU2;

FIG. 2 illustrates sharing of functional unit with discretion, such that no unnecessary power consumption results;

FIG. 3 illustrates sharing of functional unit with its output extending to a Shifter and Bit Extractor;

FIG. 4 illustrates sharing of functional unit with its output extending to a Shifter and Multiplier;

FIG. 5 is an overview flowchart relating to the operation of an embodiment of the invention;

FIG. 6 is a flowchart illustrating data path allocation;

FIG. 7 is a flowchart illustrating a module allocation process;

FIG. 8 is a flowchart illustrating power management costs formulation between each and every operation candidate and functional unit;

FIG. 9 is a flowchart illustrating the power management costs formulation between an operation candidate and a FU;

FIG. 10 is a flowchart illustrating the power management costs formulation between an operation candidate and an operation assigned to FU in the allocations before current operation candidate allocation;

FIG. 11 is an illustration of the unnecessary power consumption induced in the functional units with inputs connected to the output registers of the FU shared by both OP1 and OP2;

FIG. 12 is an illustration of the unnecessary power consumption induced in the functional units connected to the output of OP1 and OP2;

FIG. 13 is an illustration of the unnecessary power consumption induced in the functional units connected to the output of OP1 only;

FIG. 14 is an illustration of a computer system for implementing the apparatus and processes associated with the exemplary embodiment.

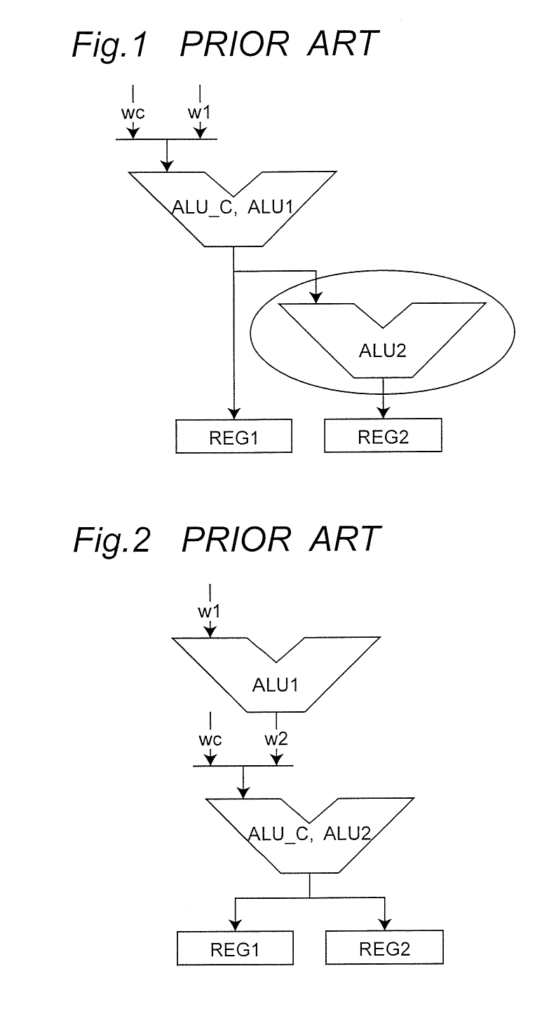

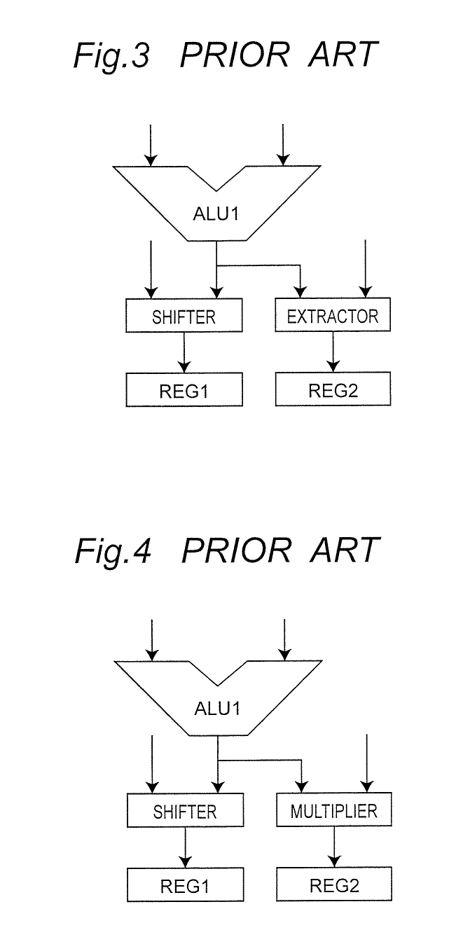

### DETAILED DESCRIPTION OF THE PREFERRED EMBODIMENTS

The data path allocation optimization phase of high-level synthesis consists of two subtasks, module allocation (operations-to-functional-units binding) and register allocation (variables-to-registers binding). The described embodiments of the invention are useful in the module allocation subtask.

The costs of power management for module allocation are compared at every allocation stage, through power management cost formulation, to yield an optimal allocation.

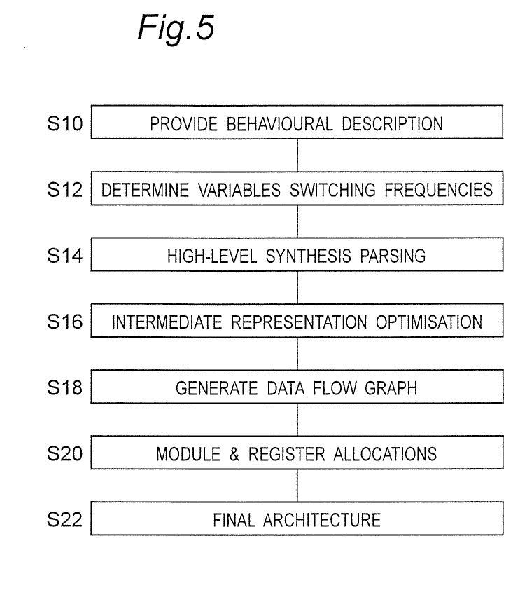

FIG. 5 is an overview flowchart relating to the operation of an embodiment of the invention to generate hardware designs.

A behavioural description of a circuit is provided (step S10). Switching frequencies of the variables for the circuit design are determined (step S12). The switching frequencies, which are computed by the upper phase of the compiler, are used during the resource allocations phase in the calculation of spurious power dissipations introduced by the sharing of modules that result in imperfectly power managed architecture.

The behavioural description is parsed (step S14) for instance by an HLScompiler. An intermediate representation is also optimised (step S16), by any one of several known ways. Common techniques to optimize intermediate representations include software pipelining, loop unrolling, instruction parallelizing scheduling, force-directed scheduling, etc. These methods are usually applied jointly to optimise intermediate representations. A data flow graph (DFG) is scheduled with the switching frequencies of the variables (step S18). The parsed description is compiled to schedule the DFG.

The modules and registers are allocated in the circuit design (step S20), as is described later, leading to a proposed architecture (step S22), in the form of an RTL design.

Data Path Allocation Program

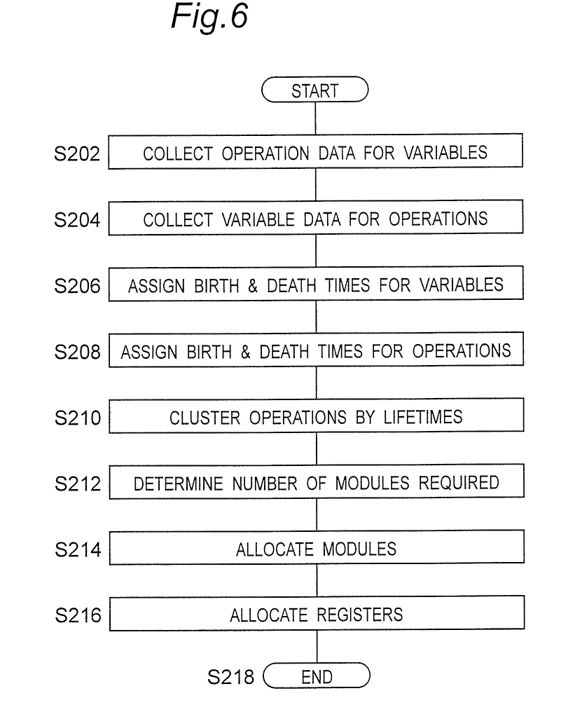

FIG. 6 is a flowchart illustrating a data path allocation process. The subtasks to accomplish within data path allocation are module allocation (operations-to-functional-units binding) and register allocation (variables-to-registers binding). In this exemplary embodiment, module allocations are carried out followed by register allocations, although it could be simultaneous or the other way round.

Operation data for every variable is collected (step S202), that is information on the operations at which the variables are derived (Op_from) to the operations where the variables are used (Op_destinations). Variable data for every operation is collected (step S204), that is information on the variables used and derived by every operation. A birth time and a death time is assigned to every variable (step S206), from an analysis of the operation data for every variable. A birth time and a death time is assigned to every operation (step S208).

The operations are first grouped according to the functions required, that is by module type. Operations requiring the same module types, i.e. operations that could share the same functional units, are clustered according to their lifetimes and death times (based on birth and death) (step S210). The operations are first sorted in ascending order according to their birth times. A cluster of mutually unsharable operations is allocated according to the sorted order (two operations are unsharable if and only if their lifetimes overlap). The number of modules of each type required is determined (step S212). For each potential type of module, the required number is the maximum number of operations that could share that type of module, which occur simultaneously in any one control step. The total number of modules of each type may be more than but no fewer than the maximum number of operations in any one cluster of operations using that module type. Modules are then allocated to the different operations (S214).

The variables are assigned to the registers next.

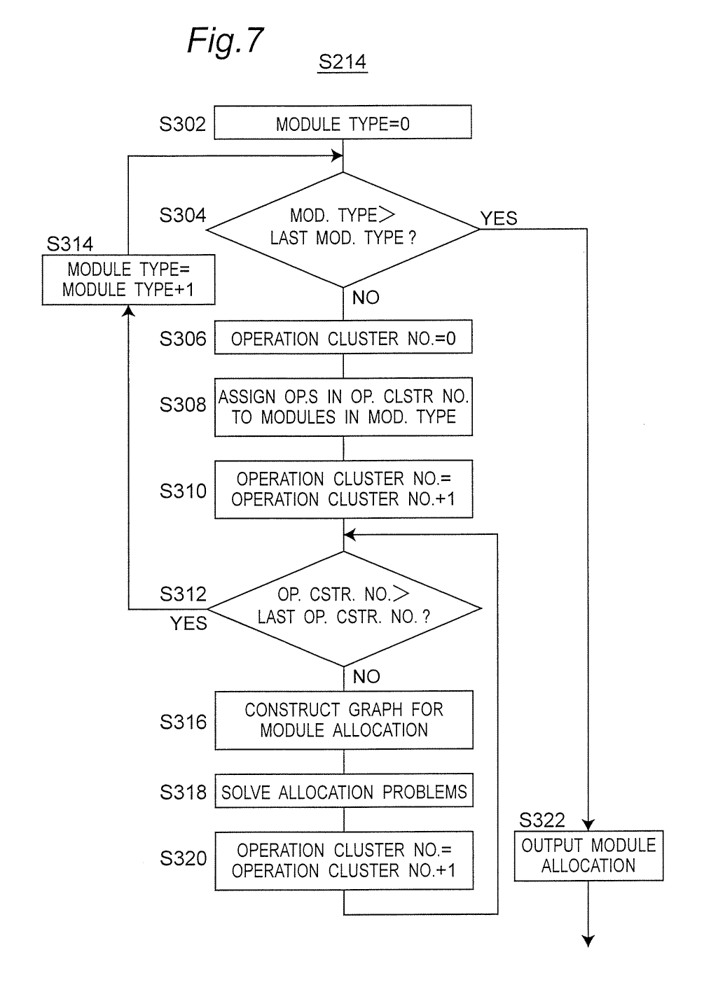

An example of the step of allocating modules (step S214 of FIG. 6) is now described with reference to FIG. 7.

The module types are all allocated a module type number. Modules that could share a common functional unit are grouped under the same module type. All modules of the same module type have the same latency (time from birth to death). The module type numbers allocated to the module types are allocated in descending latency order. That is the module type with the highest latency has the lowest module type number (i.e. 0) and the module type with the lowest latency has the highest module type number. Module types of the same latencies are allocated different successive numbers randomly Likewise, each cluster of operations for each module type is allocated a number.

The process of allocating modules is initiated by setting a first module type to be allocated, module type=0 (step S302). A check is made of whether the current module type number is higher than the last (highest possible) module type number (step S304). If the current module type number is not higher than the last module number, a current operation cluster number is set to 0, for the current module type (step S306). All the operations in the current operation cluster number for the current module type are assigned to a different functional unit of the current module type (step S308). The modules are allocated in decreasing order of latency for the operations in the current cluster. The current operation cluster number is then increased by one (step S310).

A check is made of whether the current operation cluster number is higher than the last (highest) operation cluster number (step S312). If the current operation cluster number is higher than the last operation cluster number, the current module type number is increased by one (step S314), and the process reverts to step S304. If the new current module type number is not higher than the number of the last module type, the operations in the first operation cluster that use the modules of this next module type are allocated to modules of this next type (by step S308).

If the current operation cluster number is not higher than the last operation cluster number at step S312, a matrix or graph is constructed for module allocation (step S316). The matrix or graph is based on the existing allocation of modules (for the first operation cluster and any other operation clusters processed so far) and the current operation cluster number. Any allocation problems are solved (step S318) to produce an allocation for all the clusters processed so far for the current module type.

The current operation cluster number is then increased by one (step S320), and the process reverts to step S312.

Once the module allocation process has cycled through all the module types, step S304 will find that the module type number is greater than the last or highest module type number and the module allocation process outputs the module allocation (step S322) for all the module types.

The module allocations are carried out for operations in descending latencies order. This is because the chances of the modules having overlapped lifetimes are higher for operations of longer latencies compared with those of shorter latencies. For operations of lower latencies, the actual functional units assigned for operations of higher latencies are used in the analysis rather than the operations themselves.

The operations of sharable functional units are assigned cluster by cluster to the functional units using Bipartite Weighted Assignments. A Weighted Bipartite graph, WB=(S, T, E) is constructed to solve the matching problem, where each vertex in the graph, sᵢεS(tⱼεT) represents an operation opᵢεOP(functional unit fuⱼεFU) and there is a weighted edge, eᵢⱼ, between sᵢ and tⱼ if, and only if, opᵢ can be assigned to fuⱼ, (i.e. none of the operations that have already been bound to fuⱼ has its lifetime overlaps with opᵢ's). The weight wᵢⱼ associated with an edge eᵢⱼ is calculated according to power cost formulations (using Equation 1). The allocation of every module cluster is modelled as a matching problem on a weighed bipartite graph and solved by the well-known Hungarian Method [C. H. Padadimitriou and K. Steiglitz, Combinatorial Optimisation, Prentice-Hall, 1982], for instance as is discussed later with reference to Table 2.

Register allocation process involves the allocation of variables to registers. The common techniques to optimize the variables to registers binding process include greedy constructive approaches such as greedy algorithm or decomposition approaches such as i) clique partitioning, ii) left-edge algorithm and iii) weighted bipartite matching algorithm.

Cost formulations

Module Allocation Power Cost Formulation (for Step S316 of FIG. 7)

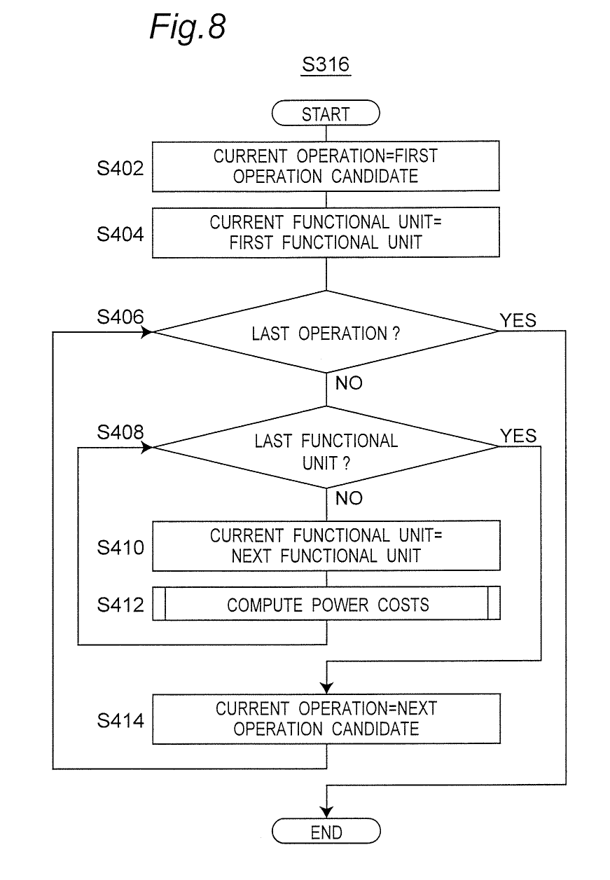

FIG. 8 is a flowchart illustrating the cost assignment process between the operation candidates and the functional units assignable for a particular cluster. Every edge of operation to functional unit is assigned power costs that would be incurred for the assignment of an operation to a functional unit. The graph edge assignment starts by evaluating the current operation assigned to the first operation candidate against the first functional unit available. The cost assignment process (S412) iterates for all the operation candidates and functional units as depicted in the figure.

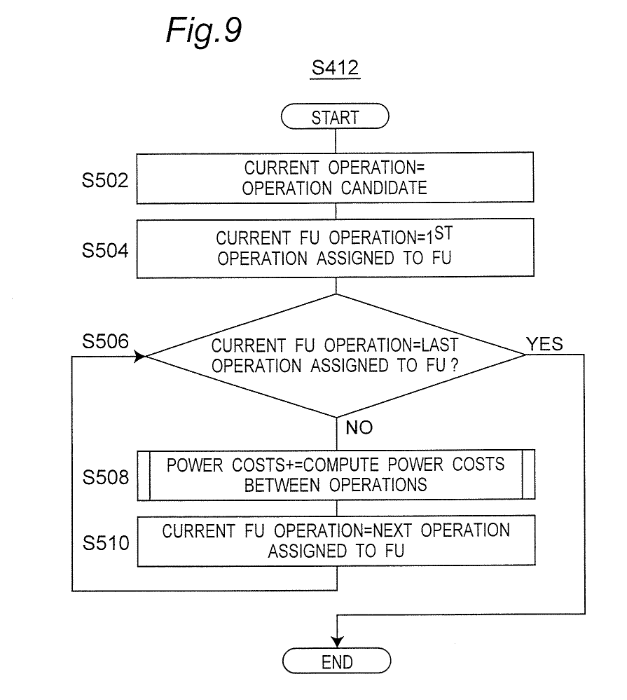

FIG. 9 is a flowchart showing the cost assignment process of Step S412. In this step, the unnecessary power costs that may be incurred on assignment of the current operation candidate to the FU are computed by evaluating the operation candidate against all operations assigned to the FU. The cost assignment begins with the current operation candidate and the first operation assigned to FU in the past allocation clusters. The evaluation against the operation candidate is performed for all the operations assigned to FU in the past allocations.

In step S508, the detailed power formulations between two operations are performed. The relevant power costs that can change in module allocation are those due to the allocation of multiplexers (MUXs) and power management costs. In module allocation, the cost formulation of power is determined as follows:

$$\begin{matrix}{f}_{power} ( x ) = ( sum of power management costs ) + \\ ( sum of multiplexer power costs )\end{matrix} \qquad ( I )$$

The only relevant area costs that can change in module allocation are those due to the number of multiplexers. Thus, in module allocation, the multiplexer power costs used in equation 1, is determined as follows:
f_{MUX}(x)=K_{MUX}*(sum of multiplexer area costs) (2)
where KMUX is the constant used to scale the area costs to the normalized power cost consumption of the MUX for the technology used

For this implementation, functional units are always shared where possible. There is no allocation of functional units greater than the minimum required. The module allocation phase is a phase to decide how to share the functional units so that at their input and at the registers input, the least MUX power usage and best power managed configurations are generated.

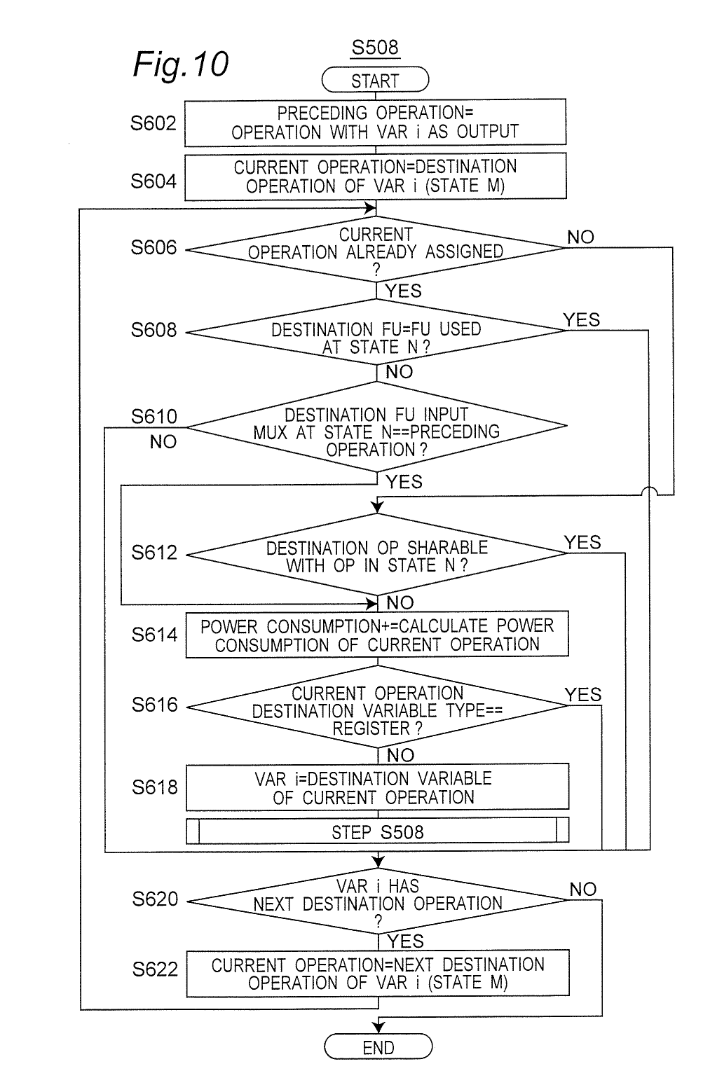

The power consumption of multiplexers (MUX) at the inputs to registers and to functional units is kept down by using Bipartite weighted assignment targets. MUX power requirements for the input and output variables of an operation are assessed in the module allocation power cost formulation, indicated in Equation 3 below, as are generated for step S614 of FIG. 10. For every allocation of an operation to a functional unit, Equation 3 is used first to assess the explicit MUX costs incurred at the input to the register (although the register is not allocated until the register allocation phase, the necessity of the register is recognised in the module allocation phase and can be costed accordingly). Equation 3 is then used to compute the implicit costs incurred at the input to the functional units.

$$\begin{matrix}{w}_{ij} = \overline{( ( Overlap ( {op}_{i} , {op}_{j} ) )} * [ ( REG\_TYPE ( {var}_{i} ) ! \\ = REG\_TYPE ( {var}_{j} ) ) \vert \\ ( ( Overlap ( {var}_{i} , {var}_{j} ) \vert \overline{( ( {Op}_{i} == {Op}_{j} ) \overline{Overlap ( {OP}_{i} , {OP}_{j} )}} ) ) * \\ {C}_{MUX} ] + Overlap ( {op}_{i} , {op}_{j} ) * MAX\end{matrix} \qquad ( 3 )$$

where

opi, opj are the operations candidate and register's past allocated operation in comparison respectively;

C_{MUX} is the estimated cost of the MUX (for instance based on the MUX bit width);

MAX is a maximum value, assigned when a match is not possible, as the operations cannot share the same functional unit (value should not be so high that the cost indicated causes overflow);

Overlap( ) returns 1 if the variables or the operations from which the variable arrives when the variable is an input variable, or the operations to which the variable passes for an output variable, have overlapping lifetimes and 0 otherwise; and

OP is either the operation from which the variable arrives when the variable is an input variable to the module, or the operation to which the variable passes for an output variable from the module.

REG_TYPE(varᵢ) the port type of the variable i, the variable type can belongs to register type or wire type;

At the input to an input of a module, an explicit MUX cost is incurred when the variables that pass to the module come from different operations. At the output from a module, an implicit MUX cost is assigned to combinations that do not pass to a common functional unit, so as to encourage sharing of modules that pass to a common functional unit over other combinations. This is because if the operations that pass to a common functional unit are assigned to different modules, an MUX cost would be incurred. The MUX costs are only implicit at this point as they may not necessarily be incurred, i.e. when none of the combinations consists of variables that pass to a common functional unit. However, whether the costs are in fact incurred is not determined until a particular module allocation has chosen and the registers are allocated. Given that implicit costs are therefore uncertain, alternative embodiments may ignore them.

If the operations have overlapping lifetimes, the modules cannot be shared. Hence the result will always be the maximum score:

Overlap(opᵢ,opⱼ)=1. Therefore ((Overlap(opᵢ, opⱼ))=0.

Thus the only result can be 1*MAX=MAX.

If the operations do not have overlapping lifetimes, Overlap(opᵢ,opⱼ)=0. Therefore Overlap(opᵢ,opⱼ)*MAX=0. However, there may still be MUX area costs. This depends on whether the variables of the operations have overlapping lifetimes and whether operations have overlapping lifetimes and whether the same operation is used for both variables. The port type of variable is a factor to consider too.

If the variables var i and var j are not of the same type, a MUX is necessary as the interface to the modules are different. To illustrate, if the inputs to a common operation are of different type, i.e. wire for one input and register for the other, a MUX at the input is required to accept the direct input from the wire at a particular clock timing and the latched output from the register at another clock timing. Thus, REG_TYPE(varᵢ)!=REG_TYPE(varⱼ)=1 when the register type is different. The result is 1*1*C_{MUX}=C_{MUX}.

If the variables of the operations have overlapping lifetimes, Overlap(varᵢ, varⱼ)=1. If the succeeding or preceding operations have overlapping lifetimes, (̅(̅O̅v̅e̅r̅l̅a̅p̅(̅O̅p̅ᵢ̅,̅ O̅p̅ⱼ̅)̅)̅=0. Therefore (̅O̅p̅ᵢ̅=̅O̅p̅ⱼ̅)̅ .̅O̅v̅e̅r̅l̅a̅p̅(̅O̅p̅ᵢ̅,̅ O̅p̅ⱼ̅)̅=1. If either the succeeding or preceding operations or the variables have overlapped lifetime and the operations do not then have an overlapping lifetime, the result is 1*1*CA_{MUX}=C_{MUX}

If the same operation is used, (Opᵢ=Opⱼ)=1. If the operations do not have overlapping lifetimes and the variables do not have overlapping lifetimes too and the register type are the same, (̅(̅O̅v̅e̅r̅l̅a̅p̅(̅O̅p̅ᵢ̅,̅ O̅p̅ⱼ̅)̅)̅=1. Therefore (̅O̅p̅ᵢ̅=̅O̅p̅ⱼ̅)̅ .̅O̅v̅e̅r̅l̅a̅p̅(̅O̅p̅ᵢ̅,̅ O̅p̅ⱼ̅)̅=0 and Overlap(varᵢ, varⱼ)=0 and REG_TYPE(varᵢ)!=REG_TYPE(varⱼ)=0. Therefore the MUX area cost is zero.

An MUX is necessary if the variables have overlapping lifetimes, as they cannot share a common register. If the variables do not have overlapping lifetimes, the variables can share a common register or a common input or output port of a functional unit. At the input to a shared register an MUX cost is avoided if the variables assigned to the register succeed from a common functional unit. This is only possible if the variables both succeed from similar operations that could share a functional unit and these operations do not have overlapping lifetimes. At the input to a functional unit, an MUX cost is avoided if the input variables to the functional unit are assigned to a common register or input port.

The total power increase in module allocation due to an MUX is proportional to the MUX area increase. K_{MUX} is a factor that scales the area of the MUX to reflect the power consumption of MUX incurred with respect to that of the registers which are used as base for power consumption of all operations. K_{MUX} can be obtained from the power measurement of some multiplexer. The average power consumed by a n-bit multiplexer is performed. This power is then normalized with the power consumed in a n-bit register. The factor K_{MUX} is obtained by dividing the normalized power by an area unit of the MUX. The power consumed by an n-bit register is used to normalize the power metrics of every operation.

Power management costs are computed for identical operations that could share the functional unit assigned to an operation of the same kind in a preceding operation cluster. The pre-condition to satisfy in power management cost computation is that the lifetimes of the output variables that are candidates for register sharing do not overlap with output variables of past allocations of a module, since module allocation is carried out with register allocation in mind so that the functional units are allocated in a manner that allows for best power management in register allocation.

The formulation of costs associated with power involves the computation of spurious activities introduced by the sharing of registers or input or output ports of functional unit. This is achieved by considering the switching activities of the variables involved in sharing and the spurious power dissipation introduced by the variables to the functional units connected to the shared register or port if the variables were to share a common register or port. Information on switching activities is determined automatically by the compiler. The spurious activities introduced by a first variable are computed from the switching activity of that first variable, multiplied by the power metrics of the unnecessarily switched operations related to the other variables with which the first variable shares a register or input or output port. Module allocation makes use of this information to share the modules.

Switching Activities Computation

The compiler assigns a default value with a known “Iteration_number” when the compiler fails to determine the switching iteration of a variable in an execution of a program. This default value is derived from previously used iteration numbers, for example an average of all previously known iteration numbers (or an average of just the last few of them, for instance the last 5). The compiler assigns known iteration numbers for variables that are executed in cycles predefined by the input program. For example, a variable is assigned iteration number of 100 if the number of loop cycles of the loop where the variable appears in is defined 100 by the input program.

Module Allocation Power management cost when both output variables are of type registers or both are of type wire

$$= {SA}_{Var 1} {\sum }_{i = 1}^{{n}_{Var 2}} Power ( i ) + {SA}_{Var 2} {\sum }_{i = 1}^{{n}_{Var 1}} Power ( i ) \qquad ( 4 a )$$

where

Var1 is a first input variable to its destination operations of interest;

Var2 is a second input variable to its destination operations of interest;

SA is the switching activity of the variable with respect to all variables;

n is the number of destination operations; and

Power is the power consumption costs obtained by computing the unnecessary signal flow from an output variable to the destination operations of interest of another variable where both operations share a common functional unit. Method is described in Step S508 (FIG. 10)

Module Allocation Power management cost when both one variable is of type register and the other variable is of type wire

$$= {SA}_{Var} {\sum }_{i = 1}^{n} Power ( i ) \qquad ( 4 b )$$

where

Var is an input variable to its destination operations of interest where variable is of type wire;

SA is the switching activity of the variable with respect to all variables;

n is the number of destination operations; and

Power is the power consumption costs obtained by computing the unnecessary signal flow from an output variable to the destination operations of interest of another variable where both operations share a common functional unit from Step S508 (FIG. 10)

A register switches when the input to it changes. However, for overall power consumption when the output of functional unit switches, whether the output is latched to a shared or unshared register, the power consumption of the registers still remains the same, i.e. one register will have to be switched. On the other hand, multiplexers that are present will consume power and they make a difference to the overall power consumption. The power management costs are costs associated only with unnecessary functional unit switching. They have no relationship to register switching or multiplexer switching power loss.

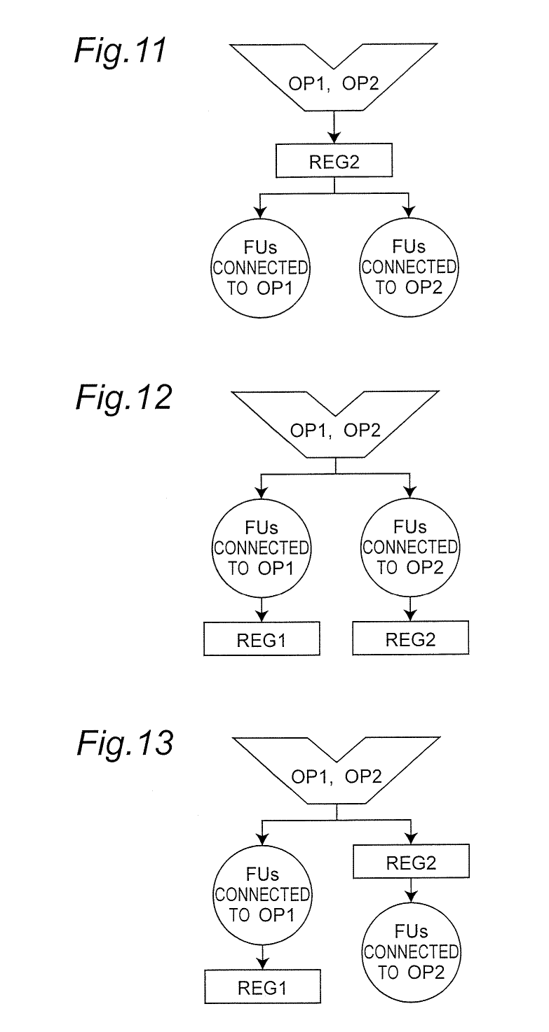

The power management costs formulation entails the usage of two equations for different scenarios. If the destination variables of both the operation candidate and the FU operations are of the same type, i.e., both of type wire or both of type register, Equation 4a is used, otherwise Equation 4b is used. If both variable types are of register, the output variable may share the same registers, thus the unnecessary power consumptions induced by each variable at the output of the registers are to be taken into considerations. As illustrated in FIG. 11, when the register switches value for OP1, the FU connected to OP2 is switched unnecessarily and vice versa.

If both variable types are of wire, the output variable will each induce unnecessary switching in the destination operation of the other variable. This unnecessary switched signal that flows through the series of inter connected operations gets terminated by an output register or multiplexer. FIG. 12 illustrates the unnecessary switching which may be induced by such connections.

On the other hand, if one variable type is of wire while the other is of register, the signal flow from the variable of type wire will not induce in unnecessary power consumption in the other variable of type register. This is because the register will not be latched at that particular state. However, the signal flow of the output variable of type register will results in unnecessary power consumption via the operation connected to the output variable of type wire when the former variable is switched. The signal flow of the unnecessarily switched operations terminates at the input to the registers or an input to the multiplexer. Refer to FIG. 13, the FU connected to the output of OP1 is unnecessarily switched when the shared FU switches for the output variable of OP2. When the shared FU is executed for the output variable of OP1, it does not result in the switching of REG2 as the register is not latched at this clock. Thus Equation 4b is used for such cases.

The process to compute the unnecessary power consumption incurred to each input variable (Step S508) is illustrated in FIG. 10. The destination operation of variable i is first evaluated. Assume that the operation i is switched at State M and the variable that results in the unnecessary switching of the destination operation is switched at State N.

The destination operation is first checked to see whether it is assigned to a FU. If it is already assigned, the usage of Destination FU in State N is checked. If it is used in State N, the power management cost computation terminates as no unnecessary power consumption results from the usage of this FU which is utilized in both State M and State N. If the FU is utilized in both states, a check is then performed on the input to the destination FU Multiplexer at State N. If the input that succeeds from its preceding operation at State N is the preceding operation of the current operation, the unnecessary power consumption is incurred at the functional unit assigned to the current operation. Therefore the power consumption cost is incremented with the normalized power consumption of the functional unit. If the input to the input multiplexer of the destination functional unit is not the preceding operation, the computation of the unnecessary power dissipation in the functional units terminates for this series of inter connected operations. The unintended signal flows is discontinued by the input to the functional unit input multiplexer.

The multiplexer information for the allocated functional is updated in Step S3 18 where the module allocations are performed.

If the current operation is not assigned yet (assignable in subsequent cluster allocation or in allocation of subsequent module types), the sharability of the operation in State N is checked (Step S612). If the operation can share the same functional unit as any of the operations in State N, the power management cost computation stops. Otherwise, the power costs that may be incurred are taken into consideration too as the existence of the input multiplexer and its signals are not known at this juncture (S614).

The power computed in Step S508 is the normalised power consumption of an operation that is not sharable with any of the destination operations of the other variable (spurious activity). If the destination variables operations are shared and utilized in both State M and State N, unnecessary power consumption does not result.

The type of the destination variable of the current operation is checked following that (Step S616). If the destination variable is of type Register, the computation of the power management costs ends here for a series of interconnected operations succeeding from variable i. The unintended result is not latched to the output register (assigned to the destination variable) for this series and there is no further unnecessary power dissipation from this point.

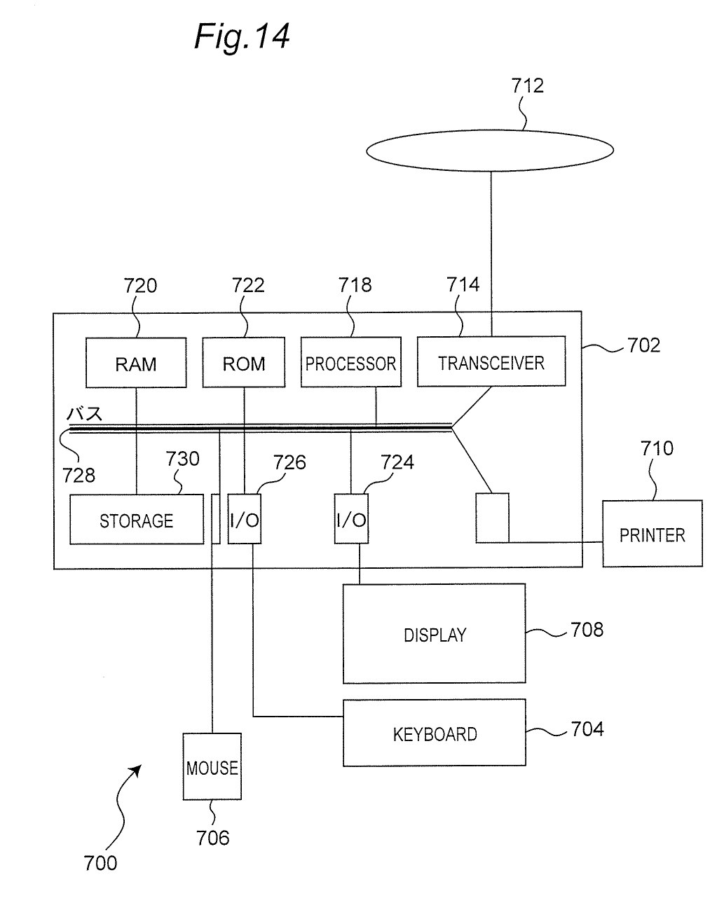

The apparatus and processes of the exemplary embodiments can be implemented on a computer system 700, for example as schematically shown in FIG. 14. The embodiments may be implemented as software, such as a computer program being executed within the computer system 700, and instructing the computer system 700 to conduct the method of the example embodiment.

The computer system 700 comprises a computer module 702, input modules such as a keyboard 704 and mouse 706 and a plurality of output devices such as a display 708, and printer 710.

The computer module 702 is connected to a computer network 712 via a suitable transceiver device 714, to enable access to e.g. the Internet or other network systems such as Local Area Network (LAN) or Wide Area Network (WAN).

The computer module 702 in the example includes a processor 718, a Random Access Memory (RAM) 720 and a Read Only Memory (ROM) 722. The computer module 702 also includes a number of input/output (S/O) interfaces, for example an I/O interface 724 to the display 708, and an I/O interface 726 to the keyboard 704. The keyboard 704 may, for example be used by the chip designer to specify the input file or the K_{MUX} constant.

The components of the computer module 702 typically communicate via an interconnected bus 728 and in a manner known to the person skilled in the relevant art.

The application program is typically supplied to the user of the computer system 700 encoded on a data storage medium such as a CD-ROM or floppy disc and read utilising a corresponding data storage medium drive of a data storage device 730. The application program is read and controlled in its execution by the processor 718. Intermediate storage of program data may be accomplished using the RAM 720.

Effects

The method and apparatus to produce high-level synthesis Register Transfer Level designs utilises power management cost formulations to produce data path of minimal unnecessary power consumption.

Operations to Functional units binding with power management formulations evaluates the unnecessary power consumptions in the various alternative bindings to arrive at bindings that consumes the least unnecessary power.

The described embodiment alleviates the problems described in the prior art by providing a mechanism that performs operations to functional unit bindings which utilizes the power management formulations of unnecessary power in the operations to functional unit bindings. The graphs of the edges of the operations to functional unit assignments are weighted according to the power management formulations to reflect the unnecessary power incurred in each and every potential allocation.

The module allocation is carried out using Bipartite Weighted assignments, with the Hungarian algorithm performed to solve the matching problems of these assignments. The Hungarian algorithm has a low complexity of O(n³) and thus the assignments are not time consuming.

The above embodiments are described with reference to allocating data paths to a electronic circuit, for instance for a decoder or encoder. However, the processes described could be used for allocating data paths for other circuits, such as an optical/photonic one, as would readily be understood by the man skilled in the art.

In the foregoing manner, a method and apparatus for allocating data paths are disclosed. Only several embodiments are described but it will be apparent to one skilled in the art in view of this disclosure that numerous changes and/or modifications may be made without departing from the scope of the invention.

1. A method of data path allocation comprising generating allocation of resources from the Data flow Graph.

2. A method according to claim 1, wherein the comprises allocating resources on basis of good power management in functional unit sharing.

3. A method according to claim 2, wherein the generating comprises allocating resources to eliminate unnecessary power loss that can be prevented in the functional unit sharing.

4. A method according to claim 2, wherein the generating comprises allocating resources to reduce the unnecessary power loss in the functional unit sharing.

5. A method according to claim 1, wherein the generating comprises determining a cost associated with a plurality of possible allocations and selecting an allocation based on the associated costs.

6. A method according to claim 5, wherein selecting an allocation based on the associated costs comprises selecting the allocation with the lowest associated cost.

7. A method according to claim 5, wherein the associated power costs comprises the power dissipation costs of the multiplexer that would be generated in the possible allocations and the power management costs that would be incurred in the possible operations to functional units' assignments.

8. A method according to claim 7 where the power dissipation costs of the multiplexers are obtained by scaling the area of the MUX by a constant factor K_{MUX} using prior characterized average power and area obtained.

9. A method according to claim 5, further comprising automatically determining switching activities for variables.

10. A method according to claim 5, wherein default values for switching activities are determined when values are not known.

11. A method according to claim 5, further comprising calculating the relative power dissipation costs from sharing a common output port between two variables by multiplying, for each of the the variables, the rate of switching of the variable to the summation of the power metrics of a series of functional unit where the signal flow of the other variable advance until when the former variable switches, to indicate spurious power dissipations introduced in the sharing process.

12. A method according to claim 11, wherein the relative power dissipation costs are calculated according to the following formulation for input variables that are both of type registers or both of type wire:
$$= {SA}_{Var 1} {\sum }_{i = 1}^{{n}_{Var2}} Power ( i ) + {SA}_{Var2} {\sum }_{i = 1}^{{n}_{Var1}} Power ( i )$$
where
Var1 is a first input variable to its destination operations of interest;
Var2 is a second input variable to its destination operations of interest;
SA is the switching activity of the variable with respect to all variables;
n is the number of destination operations; and
Power is the power consumption costs obtained by computing the unnecessary signal flow from an output variable to the destination operations of interest of the other variable which shares a common functional unit output port with the former variable.

13. A method according to claim 12, wherein the cost computations are included for operations that have outputs of both register type only.

14. A method according to claim 12, wherein the cost computations are included for operations that have outputs of both wire type.

15. A method according to claim 11, wherein the relative power dissipation costs are calculated according to the following formulation for functional unit sharing between operations where one input variable is of register type and the other is of wire type:
$$= {SA}_{Var} {\sum }_{i = 1}^{n} Power ( i )$$
where
Var is an input variable to its destination operations of interest where variable is of type wire;
SA is the switching activity of the variable with respect to all variables;
n is the number of destination operations; and
Power is the power consumption costs obtained by computing the unnecessary signal flow from an output variable to the destination operations of interest of the other variable which share a common functional unit output port with the former variable.

16. A method according to claim 15, wherein the cost computations are included for functional unit sharing of operations that have input variable of type wire and the other of register type only.

17. A method according to claim 12, wherein the cost of unnecessary power flow is computed until the unintended signal flow is stopped.

18. A method according to claim 17, wherein the cost of unnecessary power flow is computed until the unintended signal flow is stopped by input to an output register that is not latched at the execution time of the intended signal flow of the other variable.

19. A method according to claim 17, wherein the cost of unnecessary power flow is computed until the unintended signal flow is stopped by input to a multiplexer at the execution time of the intended signal flow from the other output variable.

20. A method according to claim 1, wherein the generating comprises allocating operations in the data path to modules.

21. A method according to claim 20, further comprising generating groups of operations that can use the same modules.

22. A method according to claim 20, further comprising generating clusters of operations that have overlapping lifetimes when allocating operations to modules.

23. A method according-to claim 21, wherein the operations are clustered by ability to use the same module and overlapping lifetimes.

24. A method according to claim 5, wherein the power dissipation costs comprise power dissipated in the multiplexers that would be generated in the possible allocations of the modules.

25. A method according to claim 24, wherein the area costs comprise explicit area costs in a particular allocation.

26. A method according to claim 24, wherein the area costs further comprise implicit area costs in a particular allocation.

27. A method according to claim 24, wherein the multiplexer power dissipation costs are computed by scaling the area of the multiplexer costs described in claim 24 and claim 25 by a constant factor decided by the relationship between characterized area and power of multiplexer.

28. A method according to claim 1, wherein the generating comprises using Bipartite Weighted Assignment allocation, with weights for power and area usage.

29. A method according to claim 20, wherein the multiplexer input to the functional units at different States are updated after every allocation of operations to the functional units.

30. A method according to claim 1, wherein the generating further comprises solving allocation matching problems using a Hungarian algorithm.

31. An apparatus for data path allocation comprising:
a resource generator for generating at least one resource while taking into account power management costs in functional unit sharing and power dissipations of a plurality of incurred multiplexers.

32. A computer program product having a computer program recorded on a computer readable medium, for data path allocation, said computer program product comprising:
an allocation of resources code segment for generating an initial allocation of resources;
a first determining code segment for determining if the allocation of resources meets at least one predetermined constraint, the at least one predetermined constraint comprising at least one of a predetermined area constraint and a predetermined power usage constraint;
a revised allocation of resources code segment for generating a revised allocation of resources based on balancing an amount of area usage and an amount of power usage;
a second determining code segment for determining if the revised allocation of resources meets the at least one predetermined constraint; and
a controlling code segment for controlling the apparatus to generate revised allocations until the at least one predetermined constraint is met.
